(19) United States
(12) Patent Application Publication
(10) Pub. No.: US 2023/0033464 A1
(43) Pub. Date: Feb. 2, 2023

(54) ELECTRONIC INSTRUMENT, METHOD FOR CONTROLLING ELECTRONIC INSTRUMENT, AND STORAGE MEDIUM

(71) Applicant: CASIO COMPUTER CO., LTD., Tokyo (JP)

(72) Inventor: Kazuto YAMAMOTO, Tokyo (JP)

(73) Assignee: CASIO COMPUTER CO., LTD., Tokyo (JP)

(21) Appl. No.: 17/864,446

(22) Filed: Jul. 14, 2022

(30) Foreign Application Priority Data
Aug. 2, 2021 (JP) 2021-126427

(51) Int. Cl. G10H 1/00; G10H 1/36

(52) U.S. Cl. CPC G10H 1/0016; G10H 1/366

(57) ABSTRACT

An electronic instrument includes at least one processor, and the at least one processor is configured to determine, based on previously acquired fingering time information relating to a time required for a fingering operation performed by a performer, a delay set time for confirming a new fingering operation in response to the new fingering operation.

### CROSS-REFERENCE TO RELATED APPLICATIONS

This application is based upon and claims the benefit of priority from the prior Japanese Patent Application No. 2021-126427, filed Aug. 2, 2021, the entire contents of which are incorporated herein by reference.

### BACKGROUND

### 1. Technical Field

The present invention relates to an electronic instrument, a method for controlling an electronic instrument, and a storage medium.

### 2. Related Art

In the related art, fingering for wind instruments such as a saxophone is difficult, and when sound with a pitch is desired to be generated, it takes time for a beginner to adjust the fingering for performing the pitch. If the sound is generated before the fingering is adjusted, the sound is generated with an incorrect pitch different from the pitch desired to be performed. In consideration of such a situation, in the related art, a time, which is described as a waiting time from start of fingering to actual sound generation, can be set in some electronic wind instruments capable of performing digital processing. An electronic instrument based on the same concept is described in, for example, JP H01-250996 A.

### SUMMARY

However, it is difficult to grasp the waiting time suitable for one's own performance, and thus a problem arises that the waiting time is set to be longer than necessary to hinder the performance, or conversely, the waiting time is set to be too short to generate undesired sound.

Therefore, one advantage of the present invention is to enable proper performance.

An electronic instrument includes at least one processor, and the at least one processor is configured to determine, based on previously acquired fingering time information relating to a time required for a fingering operation performed by a performer, a delay set time for confirming a new fingering operation in response to the new fingering operation.

### BRIEF DESCRIPTION OF THE DRAWINGS

FIG. 1 is an external appearance view of an electronic wind instrument according to an embodiment;

FIG. 2 is a hardware block diagram showing a configuration example of a control system of the electronic wind instrument according to the embodiment;

FIG. 3 is a functional block diagram according to the embodiment;

FIG. 4 is a flowchart showing main processing according to the embodiment;

FIG. 5 is a flowchart showing a detailed example of delay set time setting processing;

FIG. 6 is a hardware block diagram showing another configuration example of the control system of the electronic wind instrument according to the embodiment; and

FIG. 7 is a hardware block diagram showing still another configuration example of the control system of the electronic wind instrument according to the embodiment.

### DETAILED DESCRIPTION

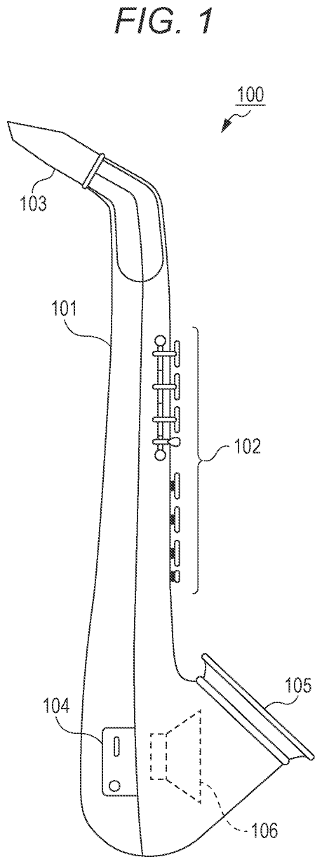

Hereinafter, an embodiment of the present invention will be described in detail with reference to the drawings. FIG. 1 is an external appearance view of an electronic wind instrument (electronic saxophone) according to an embodiment, which is a specific example of an electronic instrument to which the present invention is applied.

For example, as shown in FIG. 1, an electronic wind instrument 100 includes: a tubular instrument main body 101 having an outer shape similar to a shape of a saxophone as an acoustic wind instrument; a mouthpiece-shaped device 103 attached to one end side of the instrument main body 101 (an upper end side in the drawing); and a sound emitting portion 105 that is provided on the other end side of the instrument main body 101 (a lower end side in the drawing) and from which musical sound is emitted. As will be described later, the mouthpiece-shaped device 103 is provided with at least a breath sensor that detects a pressure of exhaled breath of a performer blown in from a blowing port of the mouthpiece-shaped device 103, and a voice sensor that detects a voice uttered by the performer. In addition, a speaker 106 that generates the musical sound is provided in an inside of the instrument main body 101 on a sound emitting portion 105 side. Further, a plurality of pitch designation keys 102 (pitch designation operators) each designating a pitch by a fingering operation are arranged on one side surface of the instrument main body 101 (a side surface on a right side in the drawing), and a switch unit 104, which includes a power supply switch of the electronic wind instrument 100 and various operation switches for controlling a performance state and the like, is provided on the other side surface of the instrument main body 101 (a side surface on a front side in the drawing). Furthermore, the instrument main body 101 is provided with a control system 200 that controls an interval, a sound volume, a tone color, and the like of the musical sound generated from the speaker 106, based on various detection signals output from the mouthpiece-shaped device 103, pitch data acquired based on the pitch designation key 102, and a control signal output from the switch unit 104.

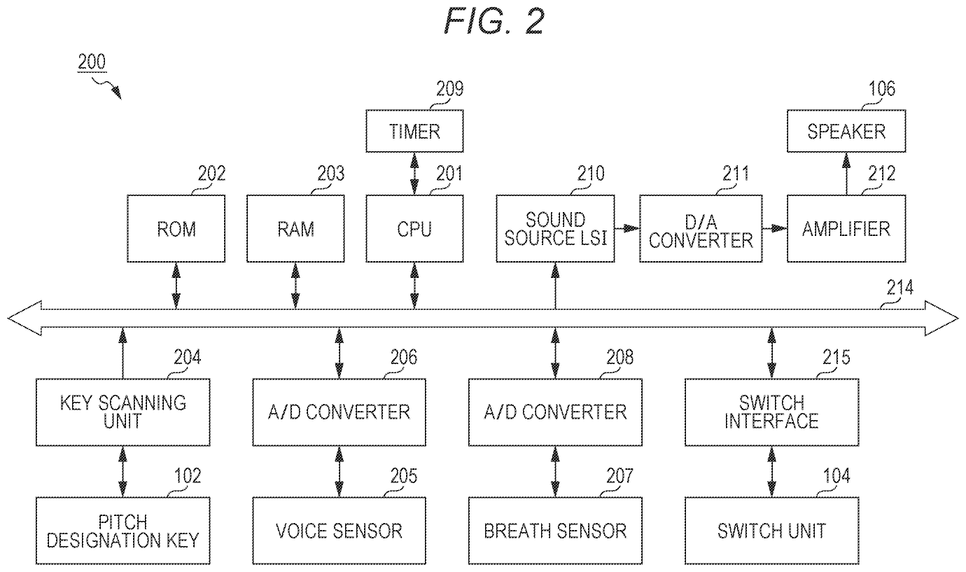

FIG. 2 is a hardware block diagram showing a configuration example of the control system 200 of the electronic wind instrument 100 according to the present embodiment. The control system 200 in FIG. 2 is an example of a control system of the electronic wind instrument 100 according to the present invention, and is not necessarily limited to the configuration.

The control system 200 is provided in the electronic wind instrument 100 and includes: at least one central processing unit (CPU) 201; a read only memory (ROM) 202; a random access memory (RAM) 203; a key scanning unit 204 to which the pitch designation keys 102 in FIG. 1 are connected; an analog/digital (A/D) converter 206 connected to a voice sensor 205; an A/D converter 208 connected to a breath sensor 207; a switch interface 215 connected to the switch unit 104; and a sound source large scale integrated circuit (LSI) 210. The above components are connected to one another via a system bus 214. The CPU 201 is connected to a timer 209 that measures a fingering time or a delay set time. The fingering time is a time required for the fingering operation. When a digital musical sound waveform signal generated by the sound source LSI 210 is output to a digital/analog (D/A) converter 211, the digital musical sound waveform signal is converted into an analog musical sound waveform signal, and the analog musical sound waveform signal is amplified by an amplifier 212 and then emitted from the speaker 106 in FIG. 1.

The CPU 201, which is a processor, executes a predetermined control program stored in the ROM 202. Accordingly, the CPU 201 instructs the sound source LSI 210, which is a sound source, to generate the musical sound waveform signal with a pitch which is designated by pitch data indicating a pitch designation state acquired based on the fingering operation performed on the pitch designation key 102. Moreover, the CPU 201 controls the pitch, a sound volume, a tone color, and the like of the musical sound waveform signal generated by the sound source LSI 210, based on various detection signals acquired by the voice sensor 205 and the breath sensor 207 in FIG. 2 in the mouthpiece-shaped device 103 in FIG. 1 during performance, and the control signal output from the switch unit 104 shown in FIG. 1.

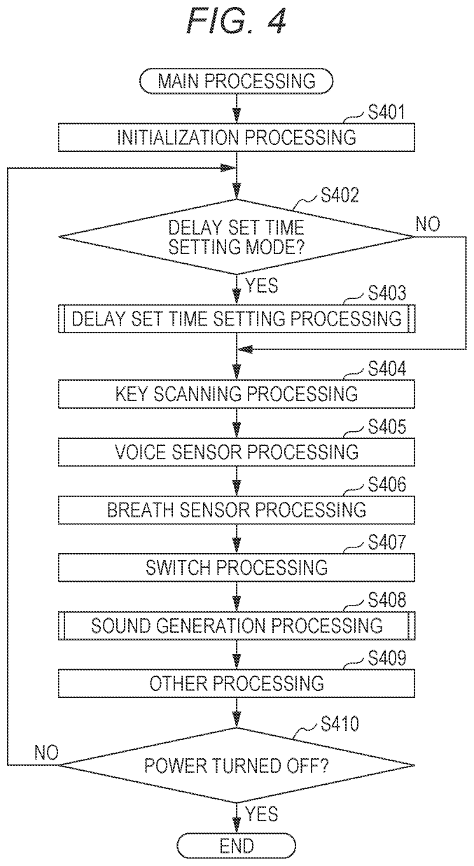

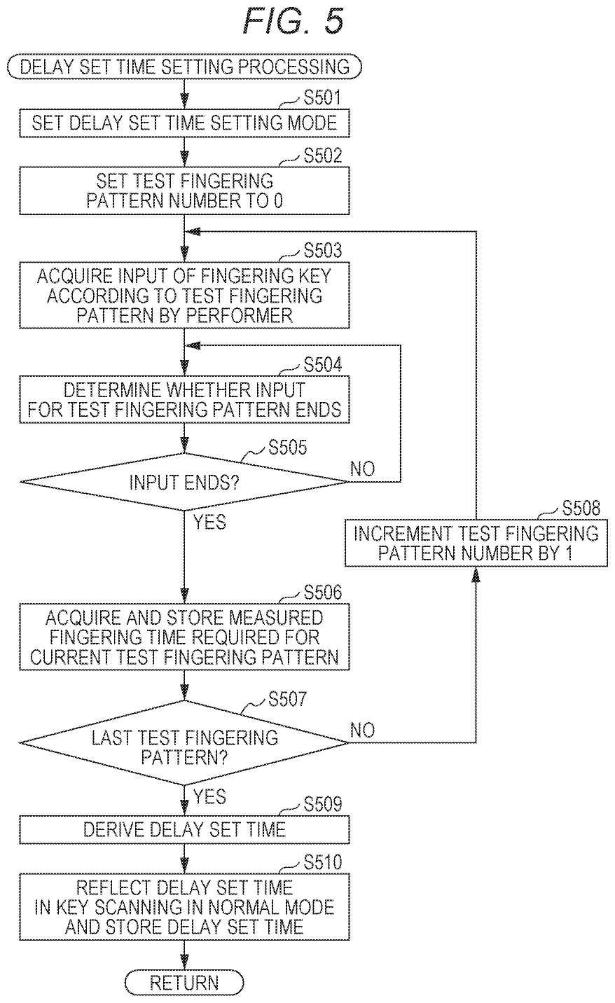

The ROM 202 stores a control program illustrated in flowcharts in FIGS. 4 and 5 to be described later, which is executed by the CPU 201 in order to control various operations during the performance of the electronic wind instrument 100. The RAM 203 appropriately acquires and temporarily stores data generated when the CPU 201 executes the control program, a signal output from the pitch designation key 102 through the key scanning unit 204, a signal output from the voice sensor 205 through the A/D converter 206, a signal output from the breath sensor 207 through the A/D converter 208, and if necessary, a signal output from the switch unit 104 through the switch interface 215 during the performance of the electronic wind instrument 100.

The pitch designation keys 102 include a plurality of pitch designation operators with which a plurality of pieces of pitch information are respectively associated. The key scanning unit 204 in FIG. 2 acquires, at a scanning interval instructed by the CPU 201, the pitch information corresponding to the fingering operation of the performer, and notifies the CPU 201 of the pitch information via the system bus 214.

The voice sensor 205 is, for example, a microphone provided in the mouthpiece-shaped device 103 in FIG. 1, and detects the voice uttered when the performer puts the mouthpiece-shaped device 103 in a mouth thereof to perform the performance An analog voltage value output as the detection signal from the voice sensor 205 is converted into a digital voltage value by the A/D converter 206 and then transmitted into the CPU 201 via the system bus 214.

The breath sensor 207 is, for example, a pressure sensor provided in the mouthpiece-shaped device 103 in FIG. 1, and detects a pressure value (breath value) based on the exhaled breath blown in from the blowing port of the mouthpiece-shaped device 103 when the performer puts the mouthpiece-shaped device 103 in the mouth to perform the performance. An analog voltage value output as the detection signal from the breath sensor 207 is converted into a digital voltage value by the A/D converter 208 and then transmitted into the CPU 201 via the system bus 214.

The sound source LSI 210 includes a synthesizer sound source, and generates, in accordance with a sound generation instruction from the CPU 201, the musical sound waveform signal, which corresponds to the pitch designated by the pitch designation key 102, and the sound volume or the like designated based on the detection signals from the voice sensor 205 and the breath sensor 207.

In the electronic wind instrument 100 and the control system 200 respectively shown in FIGS. 1 and 2, the performer hangs the instrument main body 101 from the neck by a strap (not illustrated), puts the mouthpiece-shaped device 103 in the mouth, and blows the exhaled breath in, thereby performing the performance In addition, in a growl performance method, the performer blows the exhaled breath in and simultaneously utters the voice to perform the performance These blowing states are detected by the breath sensor 207 and the voice sensor 205 in the mouthpiece-shaped device 103, and are converted into digital signals by the A/D converters 206 and 208, and the CPU 201 is notified of the digital signals. At the same time, the performer designates the pitch by performing the fingering operation on the plurality of pitch designation keys 102 in FIG. 1 and performing the performance. The designation of the pitch is notified to the CPU 201 through the key scanning unit 204. The key scanning unit 204 is an example of a performance information acquisition unit that acquires performance information on performance of a fingering pattern by the performer.

Here, unlike a keyboard of a piano or the like, the pitch designation keys 102 of the electronic wind instrument 100 are not necessarily arranged adjacent to each other to correspond to pitches adjacent to each other, fingering operations for designating the respective pitches are generally determined, and proficiency in the fingering operations is required for a beginner. When a performance level of the performer is low, at the time of designating the pitch, the performer considers a fingering corresponding to the pitch by considering in the head or referring to a fingering chart or the like and performs an operation of pressing the pitch designation key 102 according to the fingering. Therefore, a certain amount of fingering time is required until the fingering for the desired pitch is confirmed. When the performance level of the performer is high, the performer can immediately confirm, at the time of designating the desired pitch, the corresponding fingering to be performed on the pitch designation key 102. Therefore, in an electronic wind instrument in the related art, when a performance level of a performer is low, there is a high possibility that while the performer hesitates about fingering, a CPU confirms a pitch designation state of a pitch designation key and issues a sound generation instruction to a sound source LSI. As a result, a musical sound waveform signal unintended by the performer is generated from a speaker. Therefore, in the present embodiment, the CPU 201 waits for a predetermined delay set time after the key scanning unit 204 detects the fingering to be performed on the pitch designation key 102, then confirms the pitch designation state of the pitch designation key 102 output by the key scanning unit 204, and instructs the sound source LSI 210 to generate the sound according to the confirmed pitch designation state.

In this case, when the performance level of the performer is low, the fingering tends take time, and thus the delay set time is preferably longer. On the other hand, when the performance level of the performer is high, the fingering time is short, and thus the delay set time is preferably shorter. Therefore, in the present embodiment, a mode called a delay set time setting mode can be set by an operation of the switch unit 104 in FIG. 1, and in this mode, the CPU 201 measures a fingering time corresponding to a current performance level of the performer and sets the delay set time based on the measured fingering time information. Then, after the performer switches to a normal performance mode (hereinafter, referred to as “a normal mode”) by an operation of the switch unit 104, the CPU 201 operates to wait for the set delay set time after the key scanning unit 204 detects the fingering to be performed on the pitch designation key 102, then to confirm the pitch designation state of the pitch designation key 102 output by the key scanning unit 204, and to instruct the sound source LSI 210 to generate the sound according to the confirmed pitch designation state.

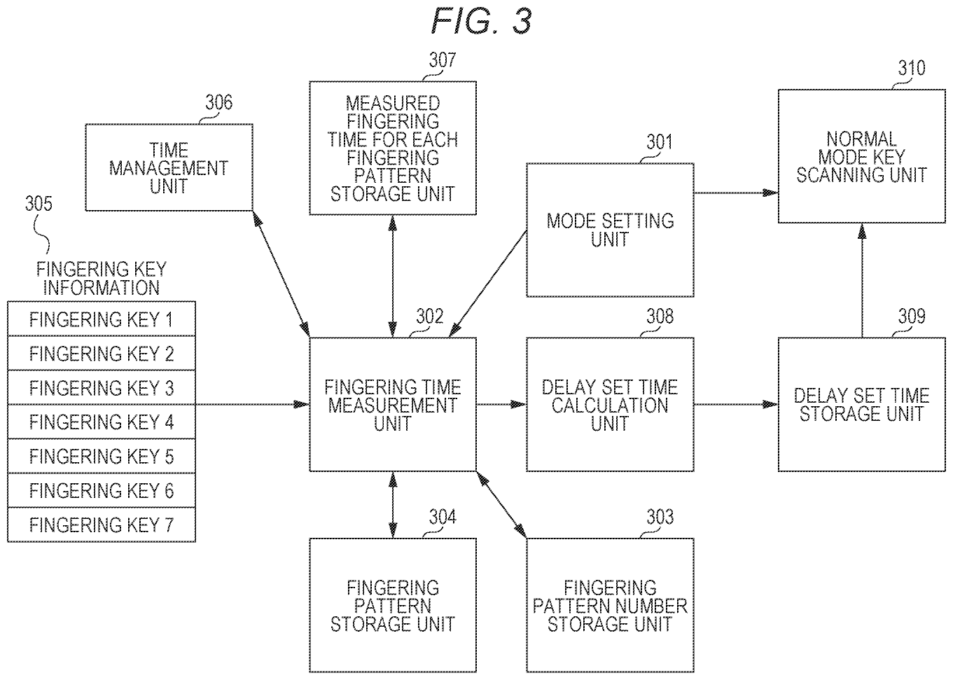

FIG. 3 is a functional block diagram showing functions of a control operation which is executed by the CPU 201 as software processing in order to implement the above operation.

First, when the performer sets a mode of the electronic wind instrument 100 to the delay set time setting mode by, for example, operating a mode switch of the switch unit 104, a mode setting unit 301 sets the delay set time setting mode. As a result, the mode setting unit 301 operates a fingering time measurement unit 302.

For each of a plurality of predetermined fingering patterns, the fingering time measurement unit 302 measures the fingering time required for the fingering operation and acquires the fingering time information by allowing the performer to sequentially perform fingering operations on the pitch designation keys 102 in FIG. 1.

Specifically, the fingering time measurement unit 302 first accesses, for example, a fingering pattern number storage unit 303 provided in the ROM 202 in FIG. 2 to read out a test fingering pattern number. For example, it is assumed that a number 1 is read out as a first fingering pattern number.

Next, the fingering time measurement unit 302 reads out a fingering pattern corresponding to the fingering pattern number 1, for example, from a fingering pattern storage unit 304 provided in the ROM 202 in FIG. 2. For example, the fingering pattern is a fingering pattern for designating a pitch “do” and then designating a pitch “re”. The performer performs, for example, fingering by designating the pitch “do” and then designating “re” according to the designated fingering pattern, and blows the mouthpiece-shaped device 103, thereby performing the performance. The performer may recognize the fingering pattern on a display (not illustrated) provided in the electronic wind instrument 100, or may recognize the fingering patterns in the order of fingering patterns printed in advance on an operation manual or the like. The processing is an example of processing performed by a fingering pattern acquisition unit that acquires the fingering pattern to be presented to the performer.

The fingering time measurement unit 302 scans the pitch designation key 102 in FIG. 1 by the key scanning unit 204 in FIG. 2, so as to measure, for example, using a time management unit 306 that is the timer 209, a time (fingering time) until the fingering pattern performed by the performer correctly designates “do” and then designates “re”, and to create the fingering time information. In this case, the fingering time measurement unit 302 emits, for example, signal sound for starting measurement from the speaker 106 through the sound source LSI 210, and the performer performs the fingering according to the signal sound. The fingering time measurement unit 302 refers to fingering key information 305 to determine whether the correct pitch designation key 102 (fingering key) is designated corresponding to the currently designated fingering pattern 1. The fingering time measurement unit 302 creates the fingering time information in which a time point when second sound is correctly fingered is an end time of the fingering time.

The fingering time measurement unit 302 stores the fingering time information measured for the fingering pattern 1 in, for example, a storage area in a measured fingering time for each fingering pattern storage unit 307 provided in the RAM 203 in FIG. 2, and the storage area corresponds to the fingering pattern 1. The fingering time information measured for the fingering pattern 1 is represented as T (do, re).

When the measurement of the fingering time for the fingering pattern 1 ends, the fingering time measurement unit 302 also executes the same fingering time measurement processing for fingering patterns 2 to 7. Here, when the fingering patterns 2, 3, 4, 5, 6, and 7 are respectively set as (re, mi), (mi, fa), (fa, so), (so, la), (la, si), and (si, do), the fingering time measurement unit 302 measures T (re, mi), T (mi, fa), T (fa, so), T (so, la), T (la, si), and T (si, do) as the fingering time information for the fingering patterns, and stores the measured T (re, mi), T (mi, fa), T (fa, so), T (so, la), T (la, si), and T (si, do) in corresponding storage areas in the measured fingering time for each fingering pattern storage unit 307.

Next, a delay set time calculation unit 308 derives the delay set time corresponding to the current performance level of the performer based on the fingering time information stored in the measured fingering time for each fingering pattern storage unit 307 and measured for the seven fingering patterns. For example, the delay set time calculation unit 308 may calculate an average value of the seven measured fingering times and set the average value as the delay set time. In addition, the delay set time calculation unit 308 may set a maximum value among the seven measured fingering times as the delay set time. The delay set time calculation unit 308 stores information of the delay set time thus calculated in, for example, a delay set time storage unit 309 provided in the RAM 203 in FIG. 2.

Subsequently, when the performer sets a mode of the electronic wind instrument 100 to the normal mode by, for example, operating the mode switch of the switch unit 104 in FIG. 1, the mode setting unit 301 sets the normal mode. As a result, the mode setting unit 301 operates a normal mode key scanning unit 310. The normal mode key scanning unit 310 is, for example, the key scanning unit 204 in FIG. 2. The normal mode key scanning unit 310 detects any fingering operation on the pitch designation key 102 in FIG. 1, then waits for the delay set time obtained using, for example, the timer 209 in FIG. 2 and stored in the delay set time storage unit 309, then confirms the fingering operation on the pitch designation key 102, and confirms the designation of the pitch based on the pitch designation state detected at a confirmation time point.

When the designation of the pitch is confirmed in the key scanning unit 204 that is the normal mode key scanning unit 310 as described above, the CPU 201 instructs the sound source LSI 210 to generate the musical sound waveform signal having the pitch corresponding to the designation of the pitch.

According to the control operation, in the electronic wind instrument 100 of the present embodiment, in the delay set time setting mode, the performer is allowed to designate a plurality of pitches, a time until the fingering for the pitch is adjusted is measured, and an appropriate delay set time is automatically set based on the measured time. Then, in the normal mode, the performer can easily set, without trial and error, the delay set time from start of the fingering on the pitch designation key 102 to start of sound generation with the sound source LSI 210.

FIG. 4 is the flowchart showing main processing according to the embodiment for implementing the control operation described with reference to FIG. 3. The main processing is an operation in which the CPU 201 in FIG. 2 reads into the RAM 203 the control program stored in the ROM 202 and executes the control program.

When a power supply is turned on, the CPU 201 executes initialization processing and executes initialization of various settings (for example, a storage state of the RAM 203) (step S401).

Subsequently, the CPU 201 repeatedly executes a series of processing of steps S402 to S409 until it is determined in step S410 that a power switch of the switch unit 104 is turned off.

In the repeated processing, the CPU 201 first determines whether the delay set time setting mode described with reference to FIG. 3 is set by operating the mode switch of the switch unit 104 in FIG. 1 by the performer (step S402).

If the determination in step S402 is YES, the CPU 201 executes delay set time setting processing (step S403). Details of this processing will be described later with reference to a flowchart in FIG. 5.

After the delay set time setting processing of step S403 or if the determination in step S402 is NO, the CPU 201 executes the following processing in the normal mode.

First, the CPU 201 executes key scanning processing (step S404). In this processing, the CPU 201 starts the measurement using the timer 209 in FIG. 2 when the key scanning unit 204 in FIG. 2 detects any fingering operation on the pitch designation key 102 in FIG. 1. Thereafter, every time the key scanning processing of step S404 is executed during repeating of the series of processing of steps S402 to S409, the CPU 201 executes scanning processing with a cycle in which a measurement value of the timer 209 is smaller than the delay set time stored in the RAM 203 by the delay set time setting processing of step S403, and repeats the scanning processing until the delay set time is reached. If the measurement value of the timer 209 reaches the delay set time, the CPU 201 confirms the fingering operation on the pitch designation key 102 and confirms the designation of the pitch based on the pitch designation state corresponding to the fingering detected by scanning at the confirmation time point, thereby ending the key scanning processing of step S404.

Next, the CPU 201 executes voice sensor processing (step S405). In this processing, the CPU 201 acquires a voice value corresponding to a magnitude of a voice sensor signal from the voice sensor 205 in the mouthpiece-shaped device 103 in FIG. 1 through the A/D converter 206.

Next, the CPU 201 executes breath sensor processing (step S406). In this processing, the CPU 201 acquires a breath value corresponding to a magnitude of a breath sensor signal from the breath sensor 207 in the mouthpiece-shaped device 103 in FIG. 1 through the A/D converter 208.

Subsequently, the CPU 201 executes switch processing (step S407). In the processing, the CPU 201 acquires an operation state of the switch unit 104 in FIG. 1 through the switch interface 215 in FIG. 2, and executes required processing corresponding to the detected switch processing.

Thereafter, the CPU 201 executes sound generation processing (step S408). In this processing, when the designation of the pitch is confirmed in the key scanning processing of step S404, the CPU 201 determines the sound volume or the like based on the voice value determined in step S405 and the breath value determined in step S406, determines the pitch corresponding to the designation of the pitch confirmed in step S404, and instructs the sound source LSI 210 in FIG. 2 to generate the musical sound waveform signal with the above pitch and sound volume. In step S408, the CPU 201 does not instruct the sound source LSI 210 to generate the sound when the fingering operation is not made in time and the designation of the pitch is not confirmed in the key scanning processing of step S404. That is, in step S408, after the key scanning unit 204 detects the fingering on the pitch designation key 102 in FIG. 1, the CPU 201 can wait for the delay set time automatically set by the delay set time setting processing of step S403, and then instruct the sound source LSI 210 to generate the musical sound waveform signal. Accordingly, it is possible to implement the electronic wind instrument 100 that appropriately responds (generates the sound) according to the performance level of the performer. In addition, in step S408, when turning off of the pitch designation key 102 in FIG. 1 is detected in, for example, the key scanning processing of step S404, the CPU 201 instructs the sound source LSI 210 to mute the musical sound waveform signal having the corresponding pitch.

Thereafter, the CPU 201 executes other processing such as envelope control of the musical sound being generated (step S409).

Finally, the CPU 201 determines whether the power switch of the switch unit 104 in FIG. 1 is turned off (step S410).

If the determination in step S410 is NO, the CPU 201 returns to the processing of step S402 and continues the series of repeated processing of steps S402 to S409.

If the determination in step S410 is YES, the CPU 201 ends the main processing illustrated in the flowchart of FIG. 4 and turns off the power supply of the electronic wind instrument 100.

FIG. 5 is the flowchart showing a detailed example of the delay set time setting processing of step S403 in FIG. 4. First, the CPU 201 sets the delay set time setting mode (step S501). This processing corresponds to a function of the mode setting unit 301 in FIG. 3. As a result of step S501, the mode setting unit 301 operates the fingering time measurement unit 302.

Next, the CPU 201 sets the test fingering pattern number to 0. In addition, the CPU 201 starts the timer 209 in FIG. 2 (heretofore, step S502).

Thereafter, the CPU 201 repeatedly executes a series of processing of steps S503 to S508 while incrementing the test fingering pattern number by 1 in step S508 until it is determined in step S507 that the processed test fingering pattern is the last test fingering pattern. The series of repeated processing correspond to a function of the fingering time measurement unit 302 in FIG. 3.

In the series of repeated processing, the CPU 201 first acquires, through the key scanning unit 204 in FIG. 2, an input of the fingering key (the fingering operation on the pitch designation key 102) according to a current test fingering pattern by the performer (step S503).

Next, the CPU 201 determines whether the input corresponding to the current test fingering pattern ends (step S504). Then, if the input does not end, determination about the end of the input in the next step S505 is NO, the processing returns to step S504 and stands by until the input ends.

If the input ends and the determination about the end of the input in step S505 is YES, the CPU 201 acquires, from the measurement value of the timer 209, the measured fingering time required for the current test fingering pattern, and stores the measured fingering time in the RAM 203. At this time, the RAM 203 corresponds to the measured fingering time for each fingering pattern storage unit 307 in FIG. 3. Thereafter, the CPU 201 stops the timer 209 (heretofore, step S506).

Thereafter, the CPU 201 determines whether the current test fingering pattern is the last test fingering pattern (step S507).

If the determination in step S507 is NO, the CPU 201 increments the test fingering pattern number by 1. In addition, the CPU 201 restarts the timer 209 in FIG. 2 from the measurement value 0 (heretofore, step S508). Thereafter, the CPU 201 returns to the processing of step S503 and continues the series of repeated processing of steps S503 to S508.

If the determination in step S507 is YES, the CPU 201 derives the delay set time corresponding to the current performance level of the performer, based on the measured fingering times for the seven test fingering patterns stored in the RAM 203 (step S509). In step S509, the CPU 201 calculates as the delay set time, for example, the average value of the measured fingering times for the seven test fingering patterns or the maximum value among the measured fingering times. This processing corresponds to a function of the delay set time calculation unit 308 in FIG. 3.

Finally, the CPU 201 stores the delay set time derived in step S509 in a storage area of the RAM 203 that can be referred to by the key scanning unit 204 in FIG. 2, so as to reflect the delay set time in the key scanning in the normal mode (step S510). At this time, the RAM 203 functions as the delay set time storage unit 309 in FIG. 3.

As described above, the delay set time stored in the RAM 203 in step S510 is referred to as the delay set time for confirming the designation of the pitch in the key scanning processing of step S404 in FIG. 4.

As described above, in the electronic wind instrument 100, even if the operation on the pitch designation key 102 performed by the performer is deviated from a blowing timing of the exhaled breath of the performer or an utterance timing of the voice of the performer in the mouthpiece-shaped device 103, the sound generation instruction can be issued by combining data acquired by the voice sensor 205 or the breath sensor 207 with data acquired at the deviated timing by the pitch designation key 102. The embodiment described above is an example in which the electronic instrument according to the present invention is the electronic wind instrument 100, but the electronic instrument may be an electronic stringed instrument in which pitch designation operators have arrangement similar to that of pitch designation operators (strings and frets) of an analog stringed instrument.

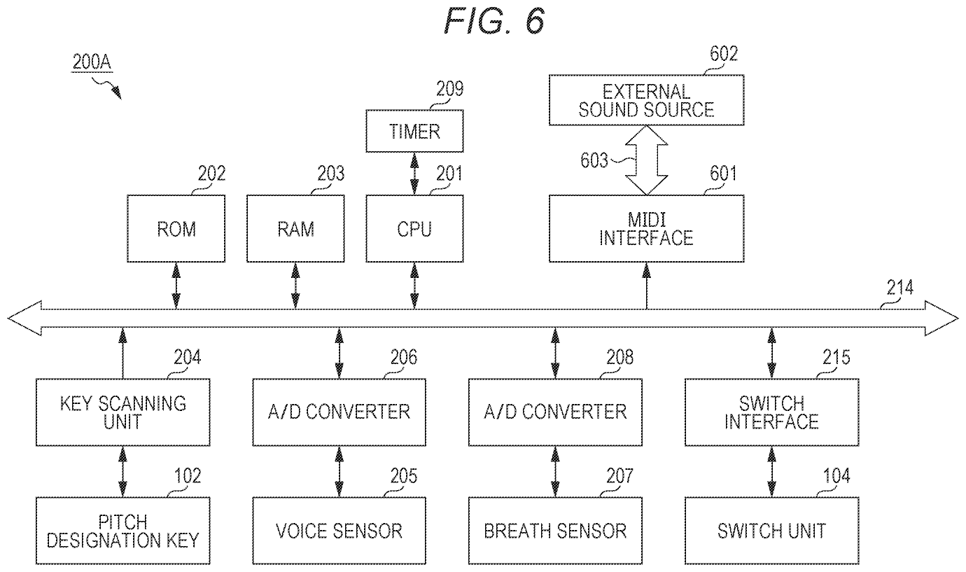

In addition, the control system of the electronic instrument according to the present invention may be configured such that one or more pieces of hardware among hardware illustrated in FIG. 2 are provided in an external device that communicates with an instrument main body such as the instrument main body 101 in FIG. 1. For example, the control system in the electronic instrument according to the present invention may be a musical instrument digital interface (MIDI: MIDI is a registered trademark) controller that does not include a sound source by itself. A configuration in this case is shown in FIG. 6. FIG. 6 is a hardware block diagram showing another configuration example of the control system of the electronic wind instrument according to the embodiment. A control system 200A illustrated in FIG. 6 includes a MIDI interface 601 in the instrument main body such as the instrument main body 101 in FIG. 1, instead of the sound source LSI 210, the D/A converter 211, the amplifier 212, and the speaker 106 in FIG. 2.

The control system 200A in FIG. 6 can output MIDI data, which is a musical sound generation command, to an outside through the MIDI interface 601, so as to cause an external sound source 602 connected to the MIDI interface 601 to generate sound. A communication path 603 between the MIDI interface 601 and the external sound source 602 may be MIDI communication in the related art via a normal 5-pin DIN cable or USB MIDI communication via a universal serial bus (USB) cable. In addition, the communication path 603 may be wireless communication according to MIDI over Bluetooth low energy (BLE-MIDI: Bluetooth is a registered trademark).

In the control system 200A in FIG. 6, in the key scanning processing of step S404 in FIG. 4, a sound generation timing for the musical sound is determined with reference to the delay set time stored in the storage area of the RAM 203 by the processing in FIG. 5. The sound generation command is output to the outside through the MIDI interface 601 at the determined sound generation timing.

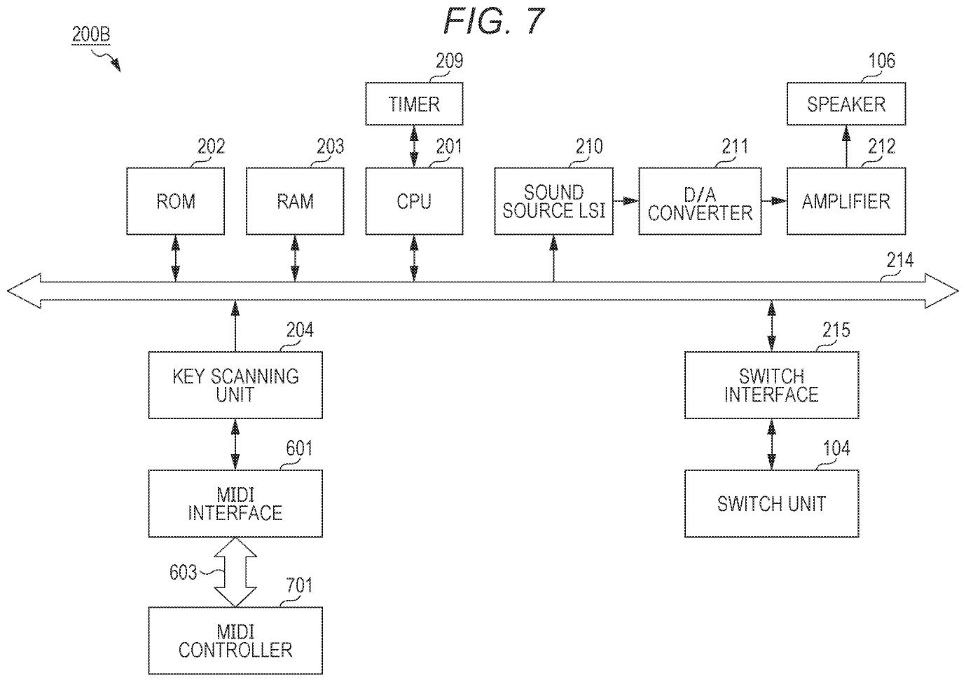

Further, the control system of the electronic instrument according to the present invention may be formed as a control device that does not include a performance operator by itself, and may acquire the performance information from an external wind instrument type or guitar type MIDI controller. A configuration in this case is shown in FIG. 7. FIG. 7 is a hardware block diagram showing still another configuration example of the control system of the electronic wind instrument according to the embodiment. In a control system 200B illustrated in FIG. 7, the key scanning unit 204 processes a MIDI command input from an external MIDI controller 701 through the MIDI interface 601, instead of the pitch designation keys 102 in FIG. 2. If the MIDI controller 701 includes the voice sensor 205, the breath sensor 207, and the associated A/D converters (206 and 208) in FIG. 2, the voice sensor 205, the breath sensor 207, and the associated A/D converters may not be included in the configuration of the control system 200B in FIG. 7. The communication path 603 is as described above with respect to the configuration example in FIG. 6, and thus a description thereof is omitted.

The control system 200B in FIG. 7 performs the delay set time setting processing in FIG. 5 by using the MIDI data input from the external MIDI controller 701 as the input of the fingering key. Similarly, in the key scanning processing of S404 in FIG. 4, when the MIDI command corresponding to the input of the fingering key is received from the MIDI controller 701, the sound source LSI 210 generates the sound after the delay set time stored in the RAM 203 elapses. Note that the voice sensor processing of S405 and the breath sensor processing of S406 in FIG. 4 may not be executed in the control system 200B in FIG. 7.

In addition, in the embodiment, the test fingering patterns are seven fixed patterns, but various fingering patterns each having a difficulty level corresponding to the performance level of the performer may be given as the plurality of fingering patterns. Further, fingering patterns corresponding to a song performed by the performer may be used in advance. In this case, even if the fingering patterns are the same, the delay set times are different from each other depending on immediately preceding fingering patterns, and thus the delay set times can be set individually. The test fingering patterns and the program executed in the present invention may be stored in a removable storage medium such as a USB memory, a CD, or a DVD, or may be stored in a server, instead of being stored in a memory built in the electronic instrument itself, such as the ROM 202 in FIG. 2. The electronic wind instrument 100 may acquire the test fingering patterns and the program from such a storage medium, or may acquire the test fingering patterns and the program from the server via a network.

Further, when the delay set time is derived based on the plurality of fingering patterns, instead of using the uniform average value or maximum value for the plurality of fingering patterns, the delay set time may be calculated by performing weighting according to the difficulty level of the fingering pattern, or the delay set time may be set based on a measurement time for the fingering of each fingering pattern by referring to a table in the memory.

Although some embodiments of the present invention have been described above, the present invention is not limited to the embodiments, includes combinations of the configurations of the plurality of embodiments within a feasible range, and further includes the inventions described in the claims and equivalents thereof.

What is claimed is:

1. An electronic instrument comprising:
at least one processor, wherein
the at least one processor is configured to determine, based on previously acquired fingering time information relating to a time required for a fingering operation performed by a performer, a delay set time for confirming a new fingering operation in response to the new fingering operation.

2. The electronic instrument according to claim 1, wherein
the fingering time information is information relating to a maximum time or an average time of the time required for the fingering operation performed a plurality of times.

3. The electronic instrument according to claim 1, wherein
the fingering operation includes an operation of a fingering pattern which is a combination of fingerings allowing the performer to sequentially designate any plurality of pitches.

4. The electronic instrument according to claim 1, further comprising:
a timer configured to measure the time required for the fingering operation performed by the performer.

5. The electronic instrument according to claim 1, further comprising:
a timer configured to measure the delay set time for confirming the new fingering operation in response to the new fingering operation.

6. The electronic instrument according to claim 1, wherein
a fingering pattern of the fingering operation performed by the performer for obtaining the time required for the fingering operation performed by the performer is set with a difficulty level corresponding to a performance level of the performer.

7. The electronic instrument according to claim 1, further comprising:
a pitch designation operator configured to designate pitch information.

8. The electronic instrument according to claim 7, further comprising:
a timer configured to measure the time required for the fingering operation performed by the performer, wherein
the timer is configured to measure the time required for the fingering operation performed on the pitch designation operator by the performer.

9. The electronic instrument according to claim 7, wherein
the pitch designation operator is disposed to correspond to disposition of a pitch designation operator of an analog wind instrument.

10. The electronic instrument according to claim 7, wherein
the pitch designation operator is disposed to correspond to disposition of a pitch designation operator of an analog stringed instrument.

11. A method for controlling an electronic instrument, comprising:
acquiring fingering time information relating to a time required for a fingering operation performed by a performer; and
determining, based on the acquired fingering time information, a delay set time for confirming a new fingering operation in response to the new fingering operation.

12. A non-transitory computer-readable recording medium storing a program of system, wherein the program is configured to allow a computer in an electronic instrument to:
acquire fingering time information relating to a time required for a fingering operation performed by a performer; and
determine, based on the acquired fingering time information, a delay set time for confirming a new fingering operation in response to the new fingering operation.
